(19) United States
(12) Patent Application Publication
(10) Pub. No.: US 2006/0160581 A1
(43) Pub. Date: Jul. 20, 2006

(54) Echo suppression for compressed speech with only partial transcoding of the uplink user data stream

(76) Inventors: Christopher Beaugeant, Munchen (DE); Renato Beluffi, Milano (IT); Tim Fingscheidt, Munchen (DE); Herbert Heib, Puchheim (DE); Bernd Jager, Munchen (DE); Luca Prati, Ferrara (IT); Herve Taddei, Munchen (DE)

Correspondence Address: MORRISON & FOERSTER LLP, 1650 TYSONS BOULEVARD, SUITE 300, MCLEAN, VA, 22102, US

(21) Appl. No.: 10/539,617

(22) PCT Filed: Dec. 20, 2002
(86) PCT No.: PCT/EP03/14090

§ 371 Date: Jan. 10, 2006

(30) Foreign Application Priority Data
Dec. 20, 2002 (EP) 02028587.0

(51) Int. Cl. H04B 1/38; H04M 1/00

(52) U.S. Cl. 455/570

(57) ABSTRACT

Disclosed is a method for suppressing (10) echo (z(t)) in uplink data (y(t), 12-16) originating from a terminal (2, 3), said method allowing a delay and a decrease in quality during echo suppression of uplink data originating from a wireless terminal (2, 3). According to the inventive method, original or copied downlink data (12-16) and uplink data (19-21) are analyzed in order to prepare echo suppression (10), and uplink data (19-21) is modified in the compressed state in order to reduce echo (10) by using the results of said analysis (9) of the downlink data (12-16) and uplink data (19-21).

The invention relates to method and to devices for suppressing echo in uplink data originating from a terminal.

In different telecommunications networks (especially cellular mobile radio networks such as GSM, UMTS, 3G, CDMA-based networks and other networks) an echo can occur in data sent from a terminal in the direction of the mobile radio network, which can arise by virtue of the fact that, at the terminal, acoustic signals output by a loudspeaker (which are based on downlink data transmitted from the network to the terminal) are picked up in more or less weak form by the microphone of the terminal. The microphone of the terminal thus receives acoustic signals from the user currently using the terminal by speaking into it (or using the mobile radio terminal in some other way) and in addition a weak interference noise in the form of the component (arriving as downlink data from the network at the terminal) reproduced by the loudspeaker of the terminal (of a party to the call or of their environment) of the terminal user. The voice data of the terminal user picked up by the microphone and the additional (noise) data picked by the microphone which a microphone in or for the terminal has picked up, is transmitted jointly to the other party in the terminal user's call so that in addition to the voice signal of the terminal user, the latter hears his own words as an echo (that is the speech sequence of the terminal user's other party in the call which was transmitted from the latter to the loudspeaker of the terminal, to the microphone and from the microphone via the terminal etc. back to the other party).

To counter this effect echo cancellers=echo compensators) are proposed in mobile radio networks (known for example from www.etsi.org etc. or Jacek Biala “Mobilfunk and intelligente Netze (mobile radio and intelligent networks)”, Vieweg-Verlag, ISBN 3-528-15302-4, pages 109, 127 and 344). In a switching device of a mobile radio network the data arrives for example via ATM-AAL-2 data connections or other data connections, with the data being encoded into a mobile radio codec format (especially AMR format) for compressed transmission especially over the air interface. For echo cancelation the speech encoded into the codec format (compressed state) is transcoded into a format which represents the speech over the course of time, such as the TDM (Time Division Multiplex) format (i.e. converted as regards its encoding) and the echo (of the downlink data) contained in the uplink data coming from the terminal is reduced as far as possible by taking account of the downlink data in the uplink data (echo cancellation). By avoiding this echo the speech quality is significantly improved.

The object of the present invention is, with a reduction of the echo in the uplink data coming from a terminal, to optimize as efficiently as possible the delay in data caused by echo cancellation. This is achieved by the objects of the independent claims in each case.

By transcoding the original or a copy of compressed data to be sent to the terminal (downlink data) and data coming from the terminal (uplink data) completely or partially (into TDM format etc) and analyzing this data received for reduction of the echo in non-transcoded uplink data for this coming from the terminal, a delay in the data during echo cancelation is efficiently avoided and/or a reduction in the speech quality through transcoding of data coming from the terminal is lessened.

Further features and advantages of the invention are produced by the claims and the subsequent description of an exemplary embodiment on the basis of the drawing. The Figures show:

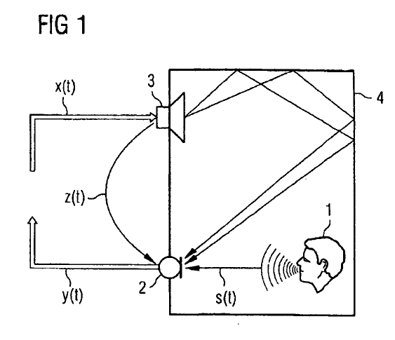

FIG. 1 a schematic diagram of how an echo is known to arise,

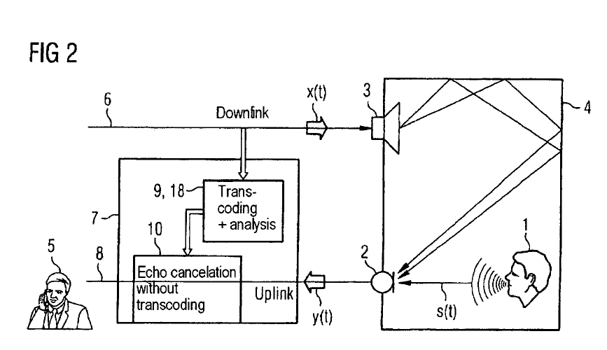

FIG. 2 a schematic of echo cancelation in accordance with the invention,

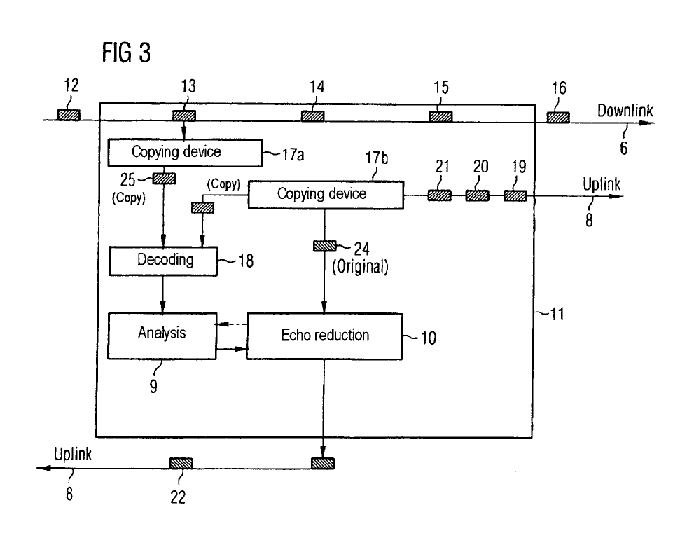

FIG. 3 the data streams for echo cancelation in accordance with the invention.

FIG. 1 shows a user 1 of a terminal (not shown) comprising items such as a microphone 2 and a loudspeaker 3 which (2,3) for example is located in a vehicle or in a room 4. The loudspeaker 3 belonging to his terminal (for example also connected via a headset or a handsfree automobile device to the terminal) receives via a mobile radio network, known per se but not shown, and a terminal downlink data x(t), to be output acoustically which propagates in the vehicle or the room 4 and is also picked up as interference noise z(t) by microphone 2 of the terminal (or for the terminal). The microphone 2 of the terminal thus receives strongly or weakly (downlink) data sent by the partner in the call of user 1 and output by the loudspeaker 3 as well as data s(t) output by the user 1 of the terminal (2, 3) as speech etc. and transmits the sum etc of the data (recorded inadvertently by loudspeaker 3 and deliberately by user 1) as signal y(t) in a known way via a mobile radio terminal, an air interface etc, to the mobile radio network and onwards to the other party in the call of subscriber 1. The other party in the call of the subscriber 1 therefore perceives an echo of his words which is to be suppressed since it reduces the speech quality.

FIG. 2 shows how, through echo cancellers, the downlink data x(t) to be transmitted or transmitted by the other party 5 in the downlink 6 via a mobile radio network, an air interface etc. to a terminal with a loudspeaker 3 is used for echo reduction.

The downlink data x(t) transmitted over the downlink 6 can be copied and in a copy (or in the original) independently of the transmission of the original (or of the copy) transcoded partly or completely in the direction of the terminal 2,3 in an echo equalizer 7 and analyzed and used for reduction (10) of the echo (8) in uplink data originating from the terminal 5 after an analysis (9). The same applies to the uplink data.

In accordance with the invention the downlink data x(t) to be sent to the terminal (in the original or its copy) and the uplink data x(t) coming from the terminal (in the copy or in the original) is transcoded (entirely or partially) and thereafter the modified data is analyzed (9), with the result of the analysis being used for echo cancelation. An echo reduction in non-transcoded uplink data avoids a deterioration (otherwise partly caused by a transcoding) of the speech quality and/or a delay. Empirical values can be obtained from analysis of downlink data and of uplink data containing an echo this data, giving details of how the uplink data can be changed without transcoding it (into a format representing the timing, e.g. the TDM format) after an analysis of transcoded downlink data, in order to reduce the echo of the downlink data in the uplink data in this way, which is possible as a rule by modifying a number of bit values in the uplink data which contain the echo of downlink data. In this case for example simplified times and amplitudes of acoustic sequences in transcoded downlink data and times in the non-transcoding uplink data can be taken into account. together with empirical values relating to times at which an echo of the downlink data of another time appears in the uplink data.

FIG. 3 shows how downlink data 12-16 to be sent to a terminal in a downlink 6 and uplink data 19-21 is copied by a copying device 17a, 17b, sent in its original form or (as here) as a copy to a decoding device 18 for encoding (transcoding into a format representing the time sequence, e.g. the TDM format), at which point it is analyzed by an analysis device 9, with the result of the analysis being able to be used by an echo reduction device 10 to reduce the echo in data 19-21 coming over an uplink 8 from a terminal, without transcoding this uplink data 24 (or alternatively its copy) for this purpose. The analysis device (9) analyzes the transcoded (18) downlink data and uplink data for an echo reduction of the uplink data. The uplink data 22 modified in the echo reduction device 10 for echo reduction is forwarded via the uplink indicated by the arrow 8 in the direction of a receiver via one or more telecommunications networks.

1. Method for suppression (10) of echo (z(t)) in uplink data (y(t) 1216) coming from a terminal (2,3),
with the original or a copy of the downlink data (12-16) and uplink data (19-21) being analyzed to prepare for echo suppression (10),
and with uplink data (19-21) in compressed state being modified for echo reduction (10) using the results of the analysis (9) of the downlink data (12-16) and of the uplink data (19-21).

2. Method in accordance with claim 1, characterized in that the non-transcoded state represents the compressed encoding in which the uplink data was transmitted compressed over a mobile radio network.

3. Method in accordance with claim 1, characterized in that, before the analysis (9), the downlink data (12-16) and the uplink data (19-21) is decoded (18) partly or entirely from the transcoded state into a format representing the timing sequence of the signals representing the data (e.g. TDM).

4. Method in accordance with claim 1, characterized in that a copy is made (17a, 17b) of at least downlink data (12-16) to be sent in the direction of the terminal or the original of the downlink data is sent to the terminal, while the other downlink-data (original or copy) is used for encoding (18) and analysis (9) to make possible echo reduction (10) in the uplink data, with only either copy or original of the downlink data being decoded.

5. Method in accordance with claim 4,
characterized in that the downlink data and the uplink data will be copied before the analysis.

6. Method in accordance with claim 1, characterized in that, during echo suppression (10) general knowledge of relationships between downlink data and required changes in uplink data is also taken into consideration for echo reduction on the uplink data using the results of the analysis (9) of the downlink data.

7. Method in accordance with claim 1, characterized in that the terminal (2, 3) is a mobile radio terminal.

8. Method in accordance with claim 7, characterized in that the terminal is a mobile radio terminal for a cellular mobile radio network.

9. Method in accordance with claim 1, characterized in that the propagation delay caused by the partial decoding of the uplink stream is less than it would be with a complete decoding of the uplink stream, subsequent echo suppression and subsequent re-encoding.

10. Device (11) for echo reduction, especially for executing the method in accordance with claim 1,
with a decoding device (18) for transcoding of downlink data to be sent to a terminal or sent to a terminal and of uplink data coming from a terminal into a format representing the timing sequence of the signals representing the data (e.g. TDM),
with an analysis device (9) for analysis of the transcoding (18) data for an echo reduction of uplink data
with an echo reduction device (10) to reduce the echo in uplink data in the non-transcoded state coming from a terminal.
